(19) United States
(12) Patent Application Publication
(10) Pub. No.: US 2008/0052355 A1
(43) Pub. Date: Feb. 28, 2008

(54) METHOD, SYSTEM, AND PROGRAM PRODUCT FOR ORGANIZING THE CONTRIBUTIONS OF EACH OF A PLURALITY OF PARTICIPANTS TO AN ELECTRONIC COMMUNICATION

(76) Inventors: John M. Lance, Littleton, MA (US); Andrew L. Schirmer, Andover, MA (US); Anuphinh P. Wanderski, Durham, NC (US)

Correspondence Address: HOFFMAN, WARNICK & D'ALESSANDRO LLC, 75 STATE ST, 14TH FLOOR, ALBANY, NY, 12207, US

(21) Appl. No.: 11/467,273

(22) Filed: Aug. 25, 2006

(51) Int. Cl. G06F 15/16

(52) U.S. Cl. 709/204; 709/206; 709/207

(57) ABSTRACT

The invention provides a method, system, and program product for organizing the contributions of each of a plurality of participants to an electronic communication. In one embodiment, the invention includes providing a list of participants to an electronic communication; accessing contents of the electronic communication; correlating at least one portion of the contents to each of the participants; and adding at least one link to the correlated contents to the list of participants, wherein the list of participants includes at least one participant whose identifying information has been predefined.

### BACKGROUND OF THE INVENTION

1. Technical Field

The invention relates generally to electronic communications, and more particularly, to the organization of the contributions of a plurality of participants to an electronic communication, such as an instant message (IM) session or an electronic mail (email) exchange.

2. Background Art

Today's electronic communications systems allow two or more individuals to communicate and collaborate in real- or near-real-time. For example, instant message (IM) sessions are now routinely used by groups of individuals to communicate and/or collaborate on a project without the need for travel to a common location or the use of expensive video or teleconferencing equipment. An additional benefit of electronic communications, particularly text-based communications such as IM sessions or electronic mail (email) exchanges, is that their contents are easily archived for later reference.

However, as the number of participants in an electronic communication increases, so too does the difficulty of keeping track of which participant made a particular comment or contributed to a portion of a collaborative document. This problem can be even more severe when participants reply to different threads of an IM session or email exchange. That is, viewing the contents of a single thread may not show the contributions or even the identities of all participants to the IM session or email exchange.

To this extent, a need exists for a method for organizing the contributions of a plurality of participants to an electronic communication.

### SUMMARY OF THE INVENTION

The invention provides a method, system, and program product for organizing the contributions of each of a plurality of participants to an electronic communication. In one embodiment, the invention includes providing a list of participants to an electronic communication; accessing contents of the electronic communication; correlating at least one portion of the contents to each of the participants; and adding at least one link to the correlated contents to the list of participants, wherein the list of participants includes at least one participant whose identifying information has been predefined.

A first aspect of the invention provides a method for organizing the contributions of each of a plurality of participants to an electronic communication, the method comprising: providing a list of participants to an electronic communication; accessing contents of the electronic communication; and correlating at least one portion of the contents to each of the participants.

A second aspect of the invention provides a system for organizing the contributions of each of a plurality of participants to an electronic communication, the system comprising: a system for providing a list of participants to an electronic communication; a system for accessing contents of the electronic communication; and a system for correlating at least one portion of the contents to each of the participants.

A third aspect of the invention provides a program product stored on a computer-readable medium, which when executed, organizes the contributions of each of a plurality of participants to an electronic communication, the program product comprising: program code for providing a list of participants to an electronic communication; program code for accessing contents of the electronic communication; and program code for correlating at least one portion of the contents to each of the participants.

A fourth aspect of the invention provides a method for deploying an application for organizing the contributions of each of a plurality of participants to an electronic communication, comprising: providing a computer infrastructure being operable to: provide a list of participants to an electronic communication; access contents of the electronic communication; and correlate at least one portion of the contents to each of the participants.

A fifth aspect of the invention provides computer software embodied in a propagated signal for organizing the contributions of each of a plurality of participants to an electronic communication, the computer software comprising instructions to cause a computer system to perform the following functions: provide a list of participants to an electronic communication; access contents of the electronic communication; and correlate at least one portion of the contents to each of the participants.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-4 show various graphical user interfaces (GUIs) of an instant message (IM) session conducted in accordance with the invention.

FIG. 5 shows a GUI of an electronic mail (email) exchange conducted in accordance with the invention.

FIG. 6 shows a flow diagram of an illustrative method according to the invention.

FIG. 7 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and program product for organizing the contributions of each of a plurality of participants to an electronic communication.

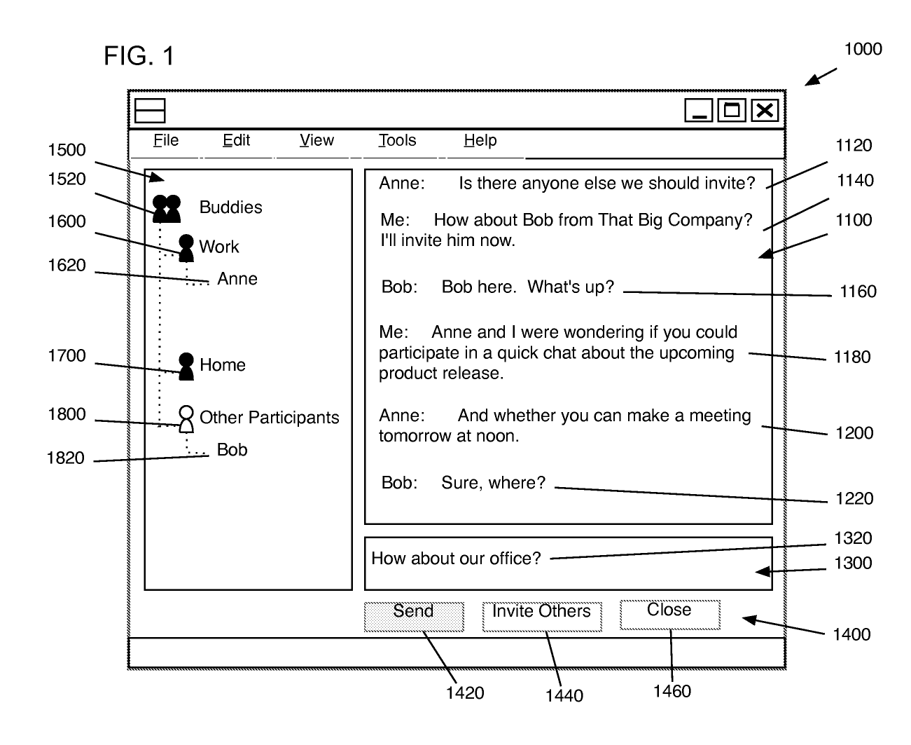

Turning now to the drawings, FIG. 1 shows an instant message (IM) graphical user interface (GUI) 1000 as may be used in the present invention. GUI 1000 includes a session window 1100 containing messages 1120 . . . 1220 of participants of an IM session, a composition window 1300 containing a message 1320 being composed by the user, a button array 1400 containing a plurality of action buttons 1420, 1440, 1460, and a participant window 1500 containing information about one or more participants to the IM session. While session window 1100, composition window 1300, and participant window 1500 are shown within a single GUI 1000, it should be recognized that one or more of such windows may optionally be included in a separate GUI, the embodiment in FIG. 1 being chosen for the sake of simplicity.

As can be seen in FIG. 1, participant window 1500 includes a buddy list 1520 containing subcategories of participants for work 1600, home 1700, and other participants 1800 (i.e., participants to an IM session whose identifying information has not been predefined or otherwise entered into buddy list 1520). For purposes of simplicity and brevity, GUI 1000 shows an IM session involving only three participants, i.e., Anne, Bob, and the user (“Me”). It should be recognized, however, that an IM session may involve dozens or even hundreds of participants. In such a case it would quickly become difficult to determine which message 1120 . . . 1220 was made by which participant. Therefore, in such a case, the present invention involves the correlation of a portion of the IM session attributable to a participant with that participant's entry in the buddy list 1520. In the example shown in FIG. 1, therefore, messages 1120 and 1200 would be correlated with Anne 1620 and messages 1160 and 1220 would be correlated with Bob 1820.

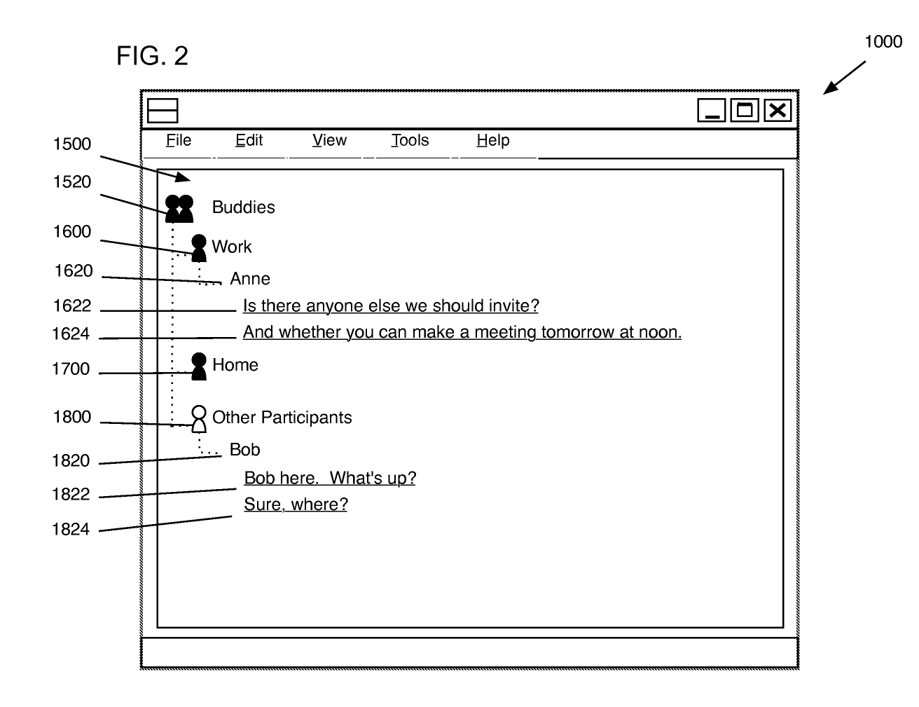

For example, referring now to FIG. 2, GUI 1000 is shown after correlation of the contents of the IM session in FIG. 1. In FIG. 2, only participant window 1500 is shown in GUI 1000, although this is not essential. GUI 1000 could also contain session window 1100, composition window 1300, button array 1400, or any other windows or devices providing additional functionality or usefulness to GUI 1000. In any case, buddy list 1520 includes, beneath the name of each participant, links (e.g., hyperlinks) to the messages sent by that participant. For example, beneath Anne 1620 appears links 1622 and 1624 to messages 1120 (FIG. 1) and 1200 (FIG. 1), respectively. Thus, a user could access and view Anne's messages simply by selecting links 1622 and/or 1624. Similarly, a user could access and view Bob's messages simply by selecting links 1822 and/or 1824.

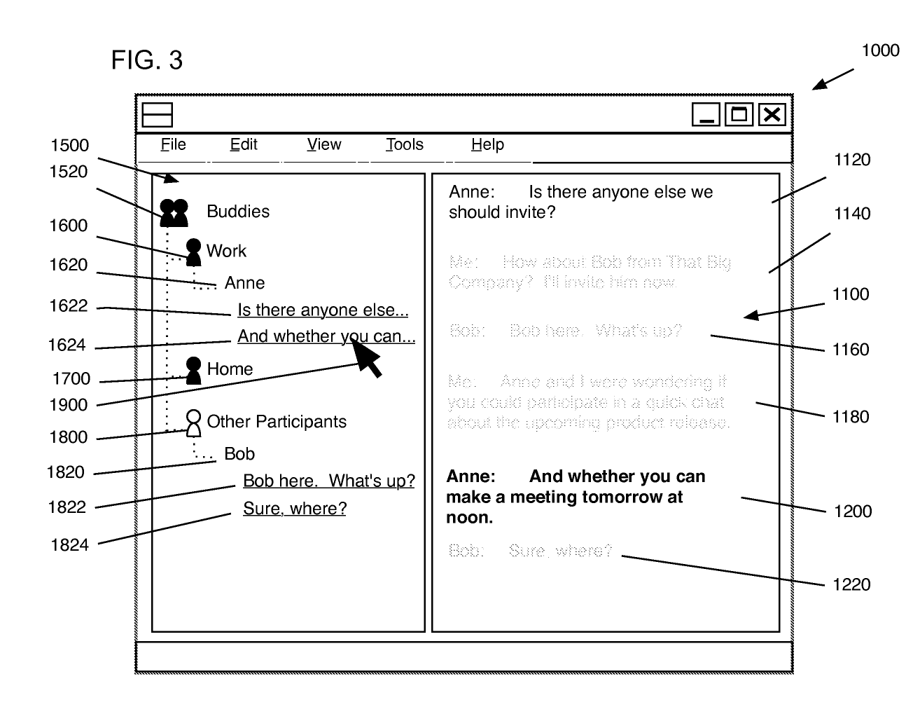

FIG. 3 shows GUI 1000 following the selection of link 1624 (using, for example, mouse cursor 1900). Session window 1100 is now shown containing the messages 1120 . . . 1220 associated with the chat to which message 1200 belongs. In order to distinguish the selected message 1200 from other messages of the IM session, message 1200 is shown in boldface type. Optionally, or in addition, non-selected messages may be shown in a “greyed-out” typeface, as are messages 1140, 1160, 1180, and 1220. In addition, non-selected messages from the same participant as the selected message may be otherwise distinguished, as is message 1120, a non-selected message from Anne. Many other methods for distinguishing selected and non-selected messages or messages from different participants are possible, of course, and are within the scope of the present invention. For example, selected and non-selected messages or messages from different participants may be shown using different fonts, using fonts of different colors, highlighting, or using identifying icons or similar devices. The particular methods for distinguishing messages shown in FIG. 3 are merely illustrative and should not be viewed as limiting the scope of the invention in any way.

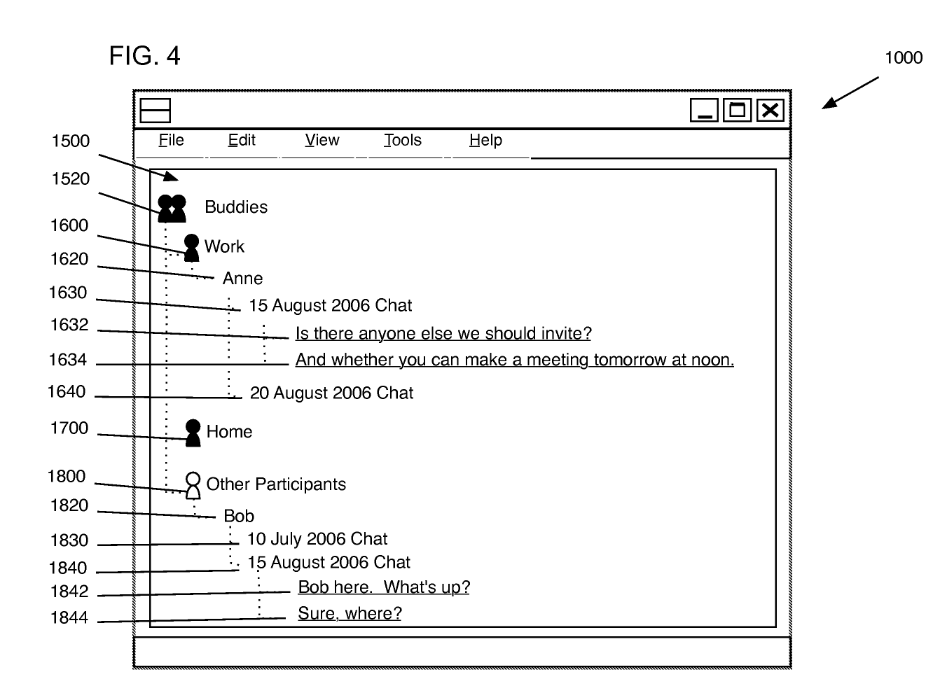

FIG. 4 shows GUI 1000 according to an alternative embodiment of the invention. Here, links 1632, 1634, 1842, 1844 are organized according to the IM session 1630, 1840 to which they pertain. Such organization may be helpful, for example, where a participant in buddy list 1520 has participated in a large number of IM sessions and the corresponding number of links is large. Thus, a user may view only those links to the messages of each participant for a single IM session. For example, rather than viewing links to all messages from Anne 1620, a user may choose to view only links 1632 and 1634 from the 15 Aug. 2006 chat 1630.

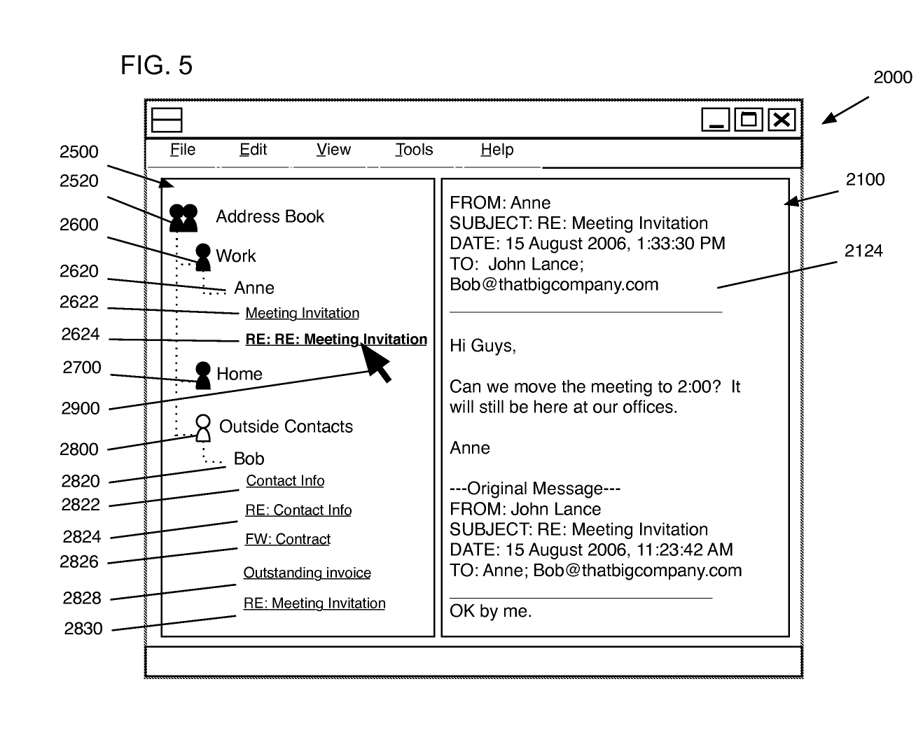

FIG. 5 shows a GUI 2000 for an electronic mail (email) application organized according to the invention. As in the IM session embodiments described above, GUI 2000 includes a participant window 2500 containing an address book 2520 and a message window 2100 containing an email message 2124. As in FIG. 3, above, address book 2520 includes links 2622, 2624, 2820 . . . 2830 to electronic communications, in this case individual email messages in an email exchange, associated with participants in the address book 2520 (i.e., Anne 2620 and Bob 2820). By selecting a link, e.g., link 2624, the email message 2124 to which it corresponds is displayed in message window 2100. Such an embodiment may be useful, for example, where an email exchange includes a large number of individual email messages or where a participant in address book 2520 has contributed email messages to a large number of email exchanges.

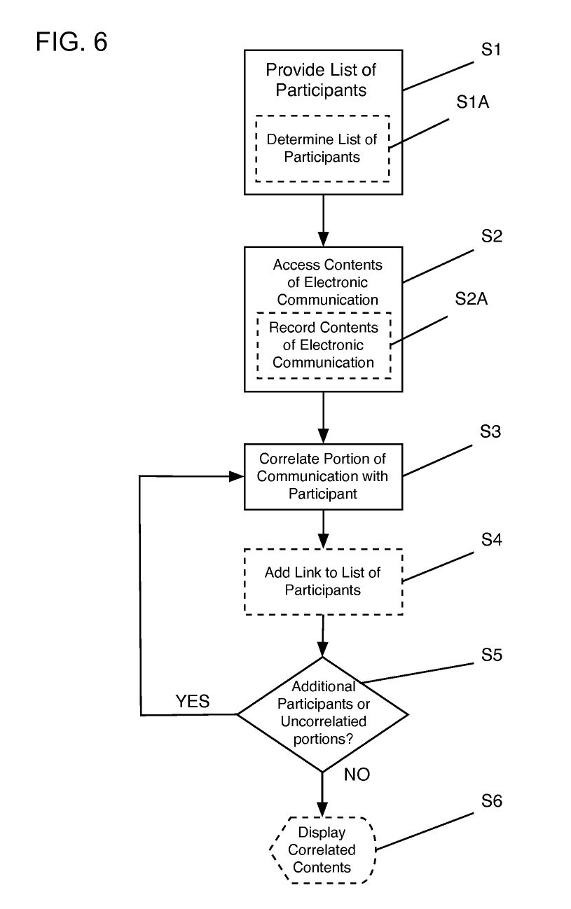

FIG. 6 shows a flow diagram of an illustrative method according to the invention. At step S1, a list of participants to an electronic communication is provided. As shown at optional step S1A, this may include determining the list of participants, which may comprise an ongoing process, wherein the list of participants is amended as additional participants join the communication. At step S2, the contents of the electronic communication are accessed. Optionally, this may include recording the contents of the electronic communication at step S2A. That is, as in step S1A, the contents of the communication, including the individual contributions of each participant, may be recorded in real-time.

At step S3, the portions of the electronic communication attributable to each participant are correlated with that participant. At optional step S4, a link to each correlated portion may be added to the list of participants, as in FIGS. 2-5. At step S5, it may be determined whether there are additional participants to the communication (i.e., those whose contributions have not been correlated) or whether there are uncorrelated portions of the communication (e.g., portions not yet correlated with a participant, whether that participant is an additional participant or a participant to whom other portions of the communication have already been correlated). If so, (i.e., “YES” at step S5), steps S3 through S5 may be iteratively looped. If not, (i.e., “NO” at step S5), the correlated contents of the communication may optionally be displayed at step S6. Any known or later-developed method or mechanism for displaying information to a user may be employed, including, for example, displaying on a computer screen.

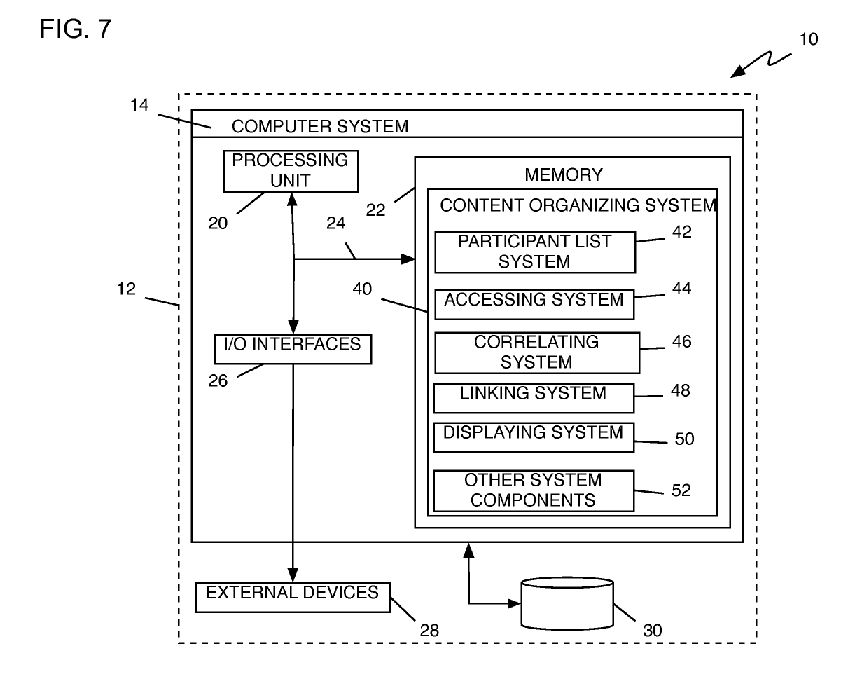

FIG. 7 shows an illustrative system 10 for organizing the contributions of each of a plurality of participants to an electronic communication. To this extent, system 10 includes a computer infrastructure 12 that can perform the various process steps described herein for organizing the contributions of each of a plurality of participants to an electronic communication. In particular, computer infrastructure 12 is shown including a computer system 14 that comprises a content organizing system 40, which enables computer system 14 to organize the contributions of each of a plurality of participants to an electronic communication by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as content organizing system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and content organizing system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, content organizing system 40 enables computer system 14 to organize the contributions of each of a plurality of participants to an electronic communication. To this extent, content organizing system 40 is shown including a participant list system 42, an accessing system 44, a correlating system 46, a linking system 48, and a displaying system 50. Operation of each of these systems is discussed above. Content organizing system 40 may further include other system components 52 to provide additional or improved functionality to content organizing system 40. It is understood that some of the various systems shown in FIG. 7 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for organizing the contributions of each of a plurality of participants to an electronic communication, it is understood that the invention further provides various alternative embodiments. For example, in one embodiment, the invention provides a computer-readable medium that includes computer program code to enable a computer infrastructure to organize the contributions of each of a plurality of participants to an electronic communication. To this extent, the computer-readable medium includes program code, such as content organizing system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to organize the contributions of each of a plurality of participants to an electronic communication as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for organizing the contributions of each of a plurality of participants to an electronic communication. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for organizing the contributions of each of a plurality of participants to an electronic communication, the method comprising:
providing a list of participants to an electronic communication;
accessing contents of the electronic communication; and
correlating at least one portion of the contents to each of the participants.

2. The method of claim 1, wherein providing the list of participants includes determining the list of participants.

3. The method of claim 1, wherein accessing the contents of the electronic communication includes recording the contents of the electronic communication.

4. The method of claim 1, further comprising:
adding at least one link to the correlated contents to the list of participants.

5. The method of claim 1, wherein the list of participants includes at least one participant whose identifying information has been predefined.

6. The method of claim 1, wherein the list of participants includes at least one participant whose identifying information has not been predefined.

7. The method of claim 1, wherein the electronic communication is a text-based communication.

8. The method of claim 7, wherein the text-based communication is selected from a group consisting of: an instant message (IM) session and an electronic mail (email) exchange.

9. A system for organizing the contributions of each of a plurality of participants to an electronic communication, the system comprising:
a system for providing a list of participants to an electronic communication;
a system for accessing contents of the electronic communication; and
a system for correlating at least one portion of the contents to each of the participants.

10. The system of claim 9, wherein the system for providing the list of participants includes a system for determining the list of participants.

11. The system of claim 9, wherein the system for accessing includes a system for recording the contents of the electronic communication.

12. The system of claim 9, further comprising:
a system for adding at least one link to the correlated contents to the list of participants.

13. The system of claim 9, wherein the list of participants includes at least one participant whose identifying information has not been predefined.

14. The system of claim 9, wherein the electronic communication is a text-based communication.

15. The system of claim 14, wherein the text-based communication is selected from a group consisting of: an instant message (IM) session and an electronic mail (email) exchange.

16. A program product stored on a computer-readable medium, which when executed, organizes the contributions of each of a plurality of participants to an electronic communication, the program product comprising:
program code for providing a list of participants to an electronic communication;
program code for accessing contents of the electronic communication; and
program code for correlating at least one portion of the contents to each of the participants.

17. The program product of claim 16, wherein the program code for providing the list of participants includes program code for determining the list of participants and the program code for accessing contents of the electronic communication includes program code for recording the contents of the electronic communication.

18. The program product of claim 16, further comprising:
program code for adding at least one link to the correlated contents to the list of participants.

19. The program product of claim 16, wherein the electronic communication is a text-based communication selected from a group consisting of:
an instant message (IM) session and an electronic mail (email) exchange.

20. A method for deploying an application for organizing the contributions of each of a plurality of participants to an electronic communication, comprising:
providing a computer infrastructure being operable to:
provide a list of participants to an electronic communication;
access contents of the electronic communication; and
correlate at least one portion of the contents to each of the participants.
